(19) United States
(12) Patent Application Publication
(10) Pub. No.: US 2003/0141990 A1
(43) Pub. Date: Jul. 31, 2003

(54) Method and system for communicating alert information to a vehicle

(76) Inventor: Bradley S. Coon, Kokomo, IN (US)

Correspondence Address: STEFAN V. CHMIELEWSKI, DELPHI TECHNOLOGIES, INC., Legal Staff Mail Code CT10C, P.O. Box 9005, Kokomo, IN, 46904-9005, US

(21) Appl. No.: 10/061,076

(22) Filed: Jan. 30, 2002

(51) Int. Cl. G08G 1/00

(52) U.S. Cl. 340/902; 340/988; 340/539.17

(57) ABSTRACT

A method and system communicates alert information to a driver of a vehicle about emergency vehicles, stopped school buses, active railroad crossings and the like (i.e., hazards) which may be relevant to the driver. The hazard (e.g., an ambulance) determines its location and transmits its coordinates to a tracking station which relays the information to a wireless data delivery center (e.g., FM radio station). The data delivery center broadcasts an alert signal containing the hazard coordinates to all the receiving vehicles in the area. A receiving vehicle determines its own location and processes the alert signal to determine if the hazard is relevant to the receiving vehicle or the driver. If the hazard is relevant, the system alerts the driver, suggests actions to be taken, or otherwise communicates the hazard information to the driver.

### Technical Field

The present invention generally relates to wireless communications networks and, more particularly, to a system for communicating alert information to vehicles regarding emergency vehicles, stopped school buses, closed railroad crossings, and the like.

### BACKGROUND OF THE INVENTION

Emergency vehicles have long been equipped with vehicle alert systems. The most familiar type of alert systems comprise warning indicators such as flashing colored lights and sirens of various types which are commonly used on emergency vehicles such as police cars, fire trucks, and ambulances. These alert systems provide an important function of alerting other drivers in the proximate area to the presence of the emergency vehicle. Effective alert systems can improve response times of these emergency vehicles.

Although these alert systems have been used for many years, they are known to be deficient for several reasons. First, these alert systems have limited range. Terrain, buildings, foliage, traffic, weather conditions, and other obstructions often block the visibility of a flashing light. Further, a driver of a vehicle may simply fail to notice a flashing light approaching, for example, from behind. Similarly, sirens have limited range due to the attenuation of the sound waves propagating through the air. The effective range of sirens may also be reduced by ambient noise, sound proofed vehicle passenger compartments, and sounds from in-vehicle entertainment systems.

The prior art has attempted to solve some of these deficiencies in several ways. Some solutions rely on light or sound detectors mounted on vehicles to detect the flashing lights or sirens of emergency vehicles and alert the driver of the vehicle. These systems may mute the audio system and activate a buzzer, siren, horn, whistle or the like in the passenger compartment to alert the driver. These systems may improve detection of some emergency vehicles; however, they remain subject to many of the same deficiencies mentioned above. Specifically, they cannot detect a flashing light that is blocked by obstructions. Similarly, sound detectors still must compete with ambient noise. Further, there is a risk of false alarms from various lights and sounds that may trigger the alarm system.

Another solution is to mount radio frequency transmitters onto the emergency vehicle that broadcast low power radio frequency signals in the vicinity of the emergency vehicle. The transmitters in these systems function as a third type of alert system (in addition to lights and sirens). The transmitted radio frequency (RF) signals are received by receivers in nearby vehicles. These systems can communicate RF signals around and through some obstacles. Further, they do not compete with ambient noise and can be connected to mute an entertainment system and to alert the driver of a receiving vehicle. While these systems provide improvements over traditional flashing lights and alarms, many of these systems have limited effective range, have no provisions for avoiding a hazard, may cause false alarms to vehicles on streets that are several blocks away, and may require additional equipment to be installed in other vehicles. This may result in large expenses for minimal improvements over traditional flashing lights and sirens.

Accordingly, it is desirable to provide for a method and system for communicating emergency vehicle or hazard alerts that has improved operation, effectiveness, utility, and reduced false alarms.

### SUMMARY OF THE INVENTION

The present invention provides for an improved method and system for communicating alerts to a driver of a vehicle. The alerts inform a driver of hazards, such as emergency vehicles (EV), stopped school buses, trains, closed railroad crossings, and the like (i.e., hazards), which may be relevant to the driver.

In one embodiment of the invention, the hazard (e.g., a fire truck) communicates its location to a tracking center which relays the information to a wireless data delivery center (e.g., FM radio station). The delivery center then broadcasts an alert signal containing the hazard location data to vehicles in a wide area. The receiving vehicles (RVs) contain a system that processes the alert signal and determines if the hazard is relevant to the vehicle or driver. If the system in the RV determines that the hazard is relevant, then the system alerts the driver, suggests actions to be taken, or otherwise communicates the information to the driver.

The hazard preferably includes a global positioning system (GPS) to determine its location. Stationary hazards, such as railroad crossing signals, can be simply programmed with their fixed location. The hazard transmits its location whenever its warning indicators (e.g., lights or sirens) are activated.

A hazard preferably transmits its location and/or status to a combined data delivery center which includes the functions of both a tracking center and a data delivery center in one location. An operator at the center may monitor the situation and combine additional data with the hazard location data. The hazard location data is then forwarded to the wide area transmitter for broadcast over a large area. In one aspect of the invention, the combined data delivery center is a commercial or public FM radio station that is configured to transmit hazard location data on a subcarrier of the station's transmit signal. This communications method allows the hazard location data to be broadcast to vehicles in a very wide area.

The RVs in the area are equipped with a receiver, a positioning system, and a processor. The receiver receives the hazard location data and communicates the data to the processor. The positioning system provides RV location data to the processor. The processor evaluates the hazard location data and determines if the hazard is relevant to the driver of the RV. If it is determined that the hazard is relevant, the system communicates an alert to the driver. The alert may include audio alerts, lights, messages on displays, or any other type of alert device. The invention is adaptable to many new vehicles because many of the necessary components are already present in the new vehicles. For example, navigation systems contain GPS units, processors suitable for implementing the algorithms of the invention, and a user interface. Telematics systems contain similar components and entertainment systems contain receivers and audio and visual user interfaces.

Communications from the hazard to the RV are completed in real-time such that appropriate actions may be taken in a timely manner by drivers. The system may also communicate additional information such as direction, speed, or destination of an emergency vehicle. Text data and audio data can also be communicated. The system in the RV scans or monitors at least one frequency for alert signals. The system preferably monitors the frequencies whenever the vehicle is in use.

The design of the present invention advantageously solves the problems of the prior art and creates an improved system and method for communicating alert information. Drivers have a longer warning time of approaching hazards, alerts are evaluated more intelligently to help avoid the hazard, and false alarms are few. The result is an improved hazard alert system that is more effective, may improve response times for emergency vehicles, and may help prevent accidents.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a diagram illustrating one embodiment of the present invention;

FIG. 2 are diagrams illustrating two alternate embodiments of the present invention;

FIG. 3 is a block diagram illustrating various components in an emergency vehicle;

FIG. 4 is a block diagram illustrating various components of data delivery centers in a radio station;

FIG. 5 is a block diagram illustrating various components in a RV; and

FIG. 6 is a flowchart of an algorithm used in a RV for communicating alert information to a driver according to the present invention.

### DESCRIPTION OF THE PREFERRED EMBODIMENTS

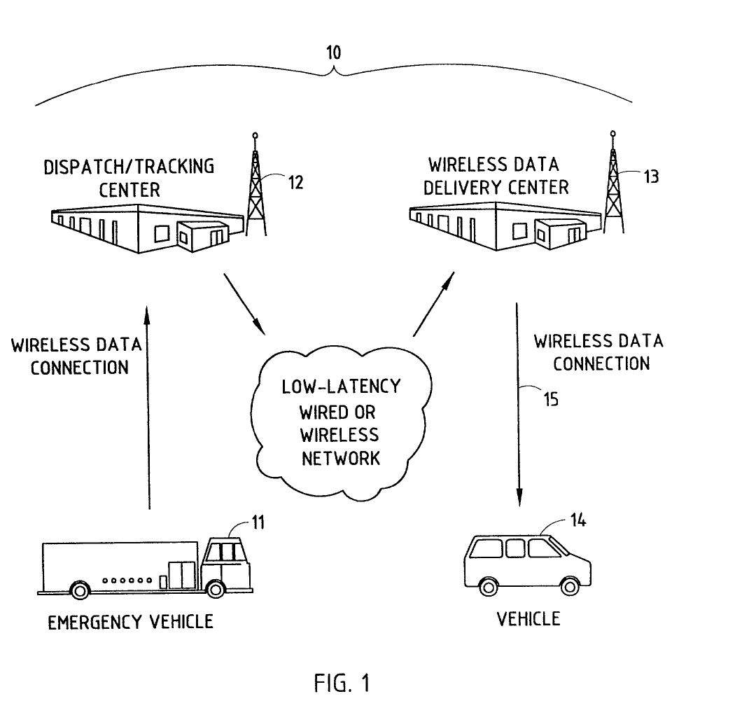

Referring to FIG. 1, the diagram illustrates the overall design of one embodiment of the alert system according to the present invention. The major components of alert system 10 include emergency vehicle (i.e., the hazard) 11, dispatch/tracking center 12, data delivery center 13, and RV 14. The EV 11 includes, for example, fire trucks, police cars, ambulances, trains, school buses, and road maintenance vehicles. Emergency vehicles 11 may be expanded to include other types of hazards such as school zones, railroad crossing signals, road construction areas, and the like. For areas such as school zones and road construction areas, a school zone warning device or construction zone warning device is equipped with a transmitter and positioned in the area. In the alternative, the tracking center or data delivery center may be notified to transmit an appropriate alert signal. RVs 14 are equipped to receive and process alert signals 15 and preferably include all types of vehicles including private vehicles, commercial vehicles, government vehicles, passenger vehicles, and trucks.

According to one aspect of the invention, EV 11 is equipped with components to automatically determine and transmit the EV's location. Preferably, emergency vehicle 11 includes a global positioning system (GPS) which provides the emergency vehicle's location. The GPS is in communication with a transmitter which transmits the emergency vehicle location data. EV 11 may also transmit additional data such as the speed, direction, destination of EV 11, and text and audio data. The transmitter is preferably coupled to the light bar and siren such that data is transmitted whenever the light bar or siren on EV 11 are active.

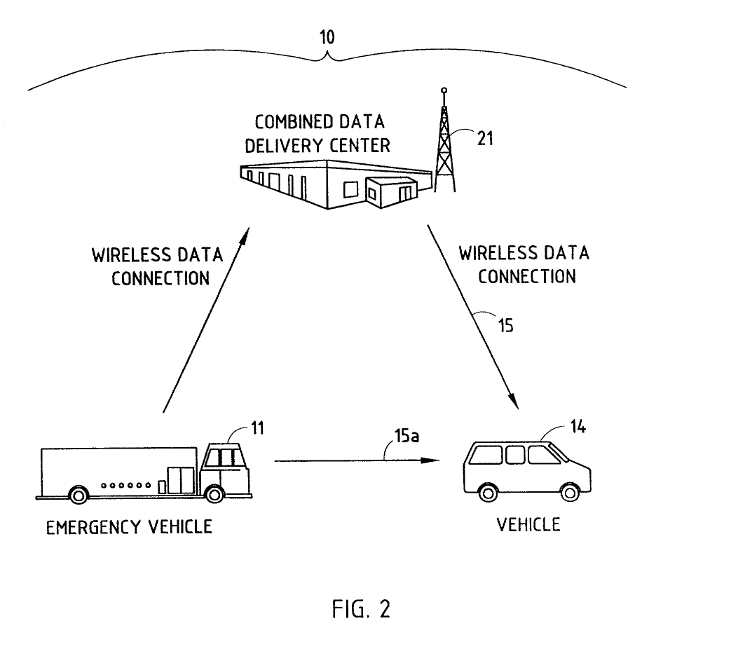

The EV transmission signal is received by an emergency vehicle dispatch/tracking center 12 which forwards the EV location data to data delivery center 13. The dispatch/tracking center 12 is capable of monitoring the data from multiple EVs 11 and enhances effectiveness by coordination of the multiple EVs 11, tracking their progress, coordinating traffic signals for the EVs 11, detecting problems with an EV 11, and efficiently solving problems which develop during the EVs travel. The dispatch/tracking center 12 may be fully automatic or monitored and controlled by a human operator. It is preferred that the dispatch/tracking center 12 be co-located with the consumer wireless data deliver center 13 as shown in FIG. 2. However, it is envisioned that environments will favor a separate dispatch/tracking center 12 which processes incoming EV data and transmits the resulting data to the data delivery center 13. The tracking center 12 also adds supplemental data to the EV data prior to transmitting the data to delivery center 13. For example, tracking center 12 may include a navigation database capable of identifying the road on which EV 11 is traveling. This road information may be included with the EV location data so that a RV 14 can display and highlight the road segment.

Data delivery center 13 receives the EV location data from the tracking center 12 and broadcasts the EV location data over a wide area. In the preferred embodiment, delivery center 13 is an FM radio station equipped to broadcast data via a subcarrier of the station's primary broadcast signal. Alternatively, the data delivery center can broadcast the EV location data via sidebands, radio data service (RDS) technology, cellular digital packet data (CDPD), other packet network technologies, wireless internet service providers (ISP), separate dedicated frequencies, various other electromagnetic radiation signals, and the like. The broadcasts are received by RV 14 which include systems for analyzing the EV or hazard location data to determine if EV 11 is relevant.

In an alternate embodiment, EV 11 always transmits location data and merely transmits an additional indicator when the light bar/sirens are activated. Either the tracking center 12 or the deliver center 13 control when signals are relayed or broadcast to RVs 14. In this embodiment a dispatcher can monitor the location of all EVs 11 it all times.

The latency between the initiation of a signal by EV 11 and receipt of the data by a RV 14 must be sufficiently short to allow a driver of RV 14 to take appropriate action in real-time. Therefore, processing of EV location data should be fully automatic. Further, the communications link between the dispatch/tracking center 12 and the data delivery center 13 must have sufficiently low-latency to allow the system to operate in real-time. The link between tracking center 12 and delivery center 13 can be either wired or wireless as long as it satisfies the low-latency requirements.

The remaining illustrated component of alert system 10 is RV 14. RV 14 is equipped with a positioning system, a receiver to receive the alert signal 15 containing the EV location data from the data delivery center 13, a processor, and an alarm for alerting the driver. The alarm may be an audio alarm such as siren, buzzer, voice messages, or various sounds generated by a speaker. Further, the alarm may be a visual alarm such as a light, display screen, head-up display, or the like. The positioning system is preferably a GPS which determines location based on transmissions front a constellation of satellites. GPS operation is well known to those skilled in the art. It is understood, however, that numerous alternative positioning systems exist including GLONASS (the Russian Federation constellation of positioning satellites), LORAN, dead reckoning/gyros, E-911, and the like. E-911 is technology developed to identify the location of a cellular telephone.

The system in the RV analyzes the location of the hazard relative to the location of the RV 14 to determine if the hazard (e.g., emergency vehicle) 11 is relevant. If the system determines that the hazard is relevant, the driver is alerted. The system may also suggest or advise the driver of actions taken such as alternate routes to avoid the hazard.

Turning to FIG. 2, there are shown two alternate embodiments of the present invention. In one aspect of the invention, the functions performed by dispatch/tracking center 12 and data delivery center 13 are combined into a single combined data delivery center 21. This invention is particularly efficient if the dispatch/tracking functions are fully automated and there is no need for an operator to monitor the system. This implementation also reduces the risk of communications failures between tracking center 12 and delivery center 13 and therefore may result in a more robust network.

Another aspect of the invention illustrated in FIG. 2 allows EV 11 to broadcast alert signal 15A containing EV location data directly to RV 14 without the need for a tracking center 12, a delivery center 13, or combined data delivery center 21. In this aspect, EV 11 performs the functions of both the tracking center 12 and the delivery center 13, albeit on a limited or reduced basis. EV 11 broadcasts its location data over a range of about one mile and preferably over five miles or more. A long range broadcast alerts RV 14 at a sufficient distance so that appropriate actions may be taken (e.g., rerouting a trip). This implementation may be less expensive to implement and particularly useful in rural areas. The problem of interference from multiple EVs broadcasting in the same area is solved by frequency sharing, using multiple frequencies, or the like. For example, if one frequency is used for multiple EVs, a protocol is used to avoid data collisions. Numerous such protocols are known in the art. Simple protocols require each transmitter to monitor the frequency prior to transmitting and waiting for a prior user to relinquish the frequency before transmitting.

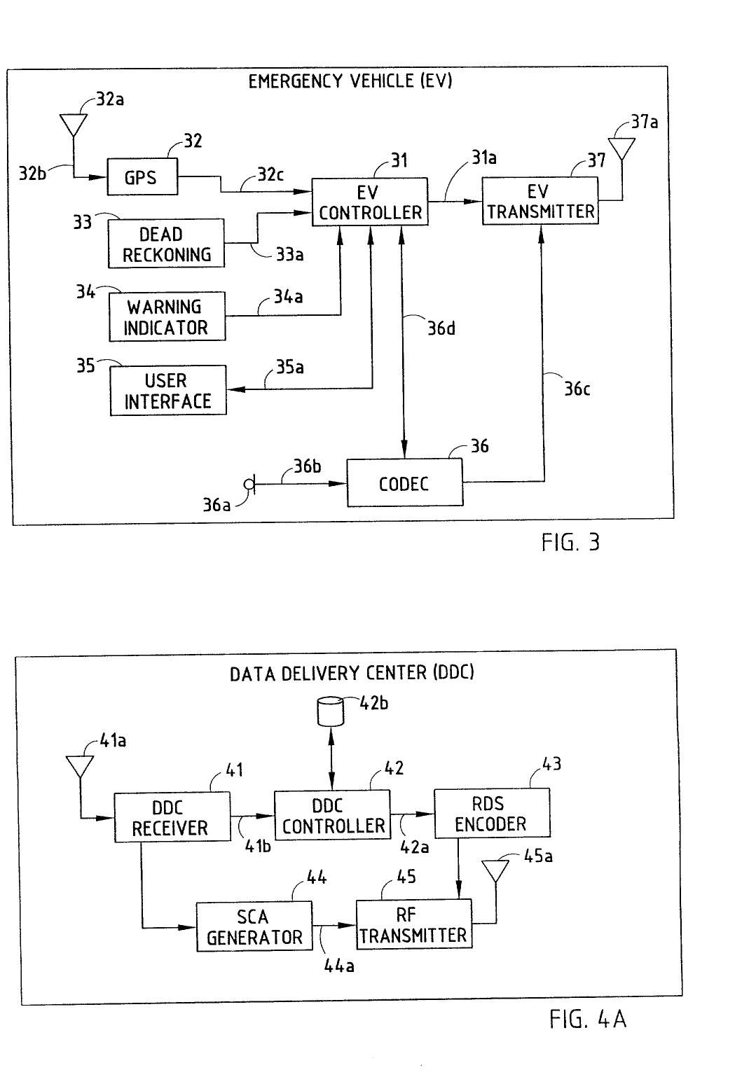

FIGS. 3 through 5 illustrate block diagrams of hardware configurations for implementing the invention in an emergency vehicle/hazard apparatus, a radio station, and a RV respectively.

Referring to FIG. 3, shown is one embodiment for an emergency vehicle/hazard 11. EV microcontroller 31 communicates with the components of the system which include GPS receiver 32, dead reckoning (DR) unit 33, warning indicator 34, user interface 35, coder/decoder (CODEC) 36, and transmitter 37. GPS receiver 31 receives positioning signals 32B via GPS antenna 32A. GPS is of conventional design and generates EV position signal 32C. EV position signal 32 preferably identifies the emergency vehicle location to within about 50 feet and more preferably to within about 20 feet. Using the EV position signal 32C, EV microcontroller 31 estimates the EV's direction of travel and speed if EV 11 is moving. DR unit 33 uses a gyroscope type sensor and vehicle speed and distance sensors to track the EV position. DR unit 33 generates a DR data signal 33A which preferably provides accurate location, heading, and velocity data without the lag times commonly associated with GPS technology. Further, DR unit 33 provides location information when the GPS receiver 32 is inoperative. Those skilled in the art will understand that various types of DR systems are available and may be used to practice this invention. EV microcontroller 31 coordinates the data from both GPS receiver 32 and DR unit 33 to compute a highly accurate EV location signal 31A which may include additional data such as direction, velocity, and status data. In alternate embodiments in which the hazard apparatus 11 is stationary (e.g., a railroad crossing signal), no active positioning system is needed. Instead, the fixed location of the hazard apparatus 11 is merely programmed, for example, into a chip or into microcontroller 31.

Location information is transmitted via EV transmitter 37 whenever warning status signal 34A indicates that warning indicator (e.g., light bar/siren) 34 is turned on. EV microcontroller 31 monitors warning status signal 34A. If the light bar/siren 34 is active, then EV location signal 31A is communicated to EV transmitter 37 and broadcast via transmitter antenna 37A. As mentioned above, EV transmitter 37 may continuously broadcast location information and either the tracking center 12 or delivery center 13 can determine if the data should be relayed to RV's 14. In alternate embodiments, warning indicator 34 may be, for example, a stop sign arm or flashing lights on a school bus or flashing lights on a railroad crossing signal.

User interface 35 allows an operator to control the EV hardware 30 and to receive output from EV microcontroller 31. In one aspect of the invention, interface 35 is merely an on/off switch. In more preferred embodiments, interface 35 is a full function interface and includes a keypad for entering commands and data and a display screen for displaying data from EV microcontroller 31. Text data may be entered via user interface 35 concerning information about a specific hazard. The text messages are then relayed to RVs 14. For example, a message may recite “ROAD CLOSED UNTIL 5:00PM” or “CONSTRUCTION ZONE-REDUCE SPEED.” Messages are crafted to provide RV 14 with the most pertinent information so that appropriate actions may be taken.

In one embodiment, EV hardware 30 includes a microphone 36A for inputting audio messages from the operator. The audio messages perform a similar function to the text messages and are crafted to inform the occupants of a RV 14 of pertinent information. In another aspect of the invention, microphone 36A is used to enter voice commands to EV microcontroller 31. Microphone 36A is coupled to a CODEC 36 which translates the audio signal 36B from microphone 36A into an appropriate format for use by transmitter 37 and/or EV microcontroller 31. Those skilled in the art should understand there are many ways to implement CODEC 36 or similar devices. CODEC 36 may translate audio signal 36B into various analog or digital formats. Audio signal 36B may also be stored in memory for periodic transmission under the control of EV microcontroller 31. Further, audio signal 36B may be compressed for efficient storage and transmission using any of the many commonly available compression techniques. The audio data is communicated to transmitter 37 via audio/transmit signal 36C. Similarly, audio data and commands are communicated between CODEC 36 and EV microprocessor 31 via CODEC bus 36D.

Data from the various components are input and processed by EV microcontroller 31. Many types of microcontrollers, microprocessors and the like are available which can perform the required functions of EV microcontroller 31. EV microcontroller 31 includes memory for storing data, variables, and program data.

In its basic function, EV microcontroller 31 first determines the current location of EV 11 and causes the coordinates to be transmitted when warning indicator 34 is activated or when an operator enters a command via user interface 35. More sophisticated embodiments include EV microcontroller 31 collecting and transmitting data such as speed and direction of EV 11, text and audio messages, failure information, and the like.

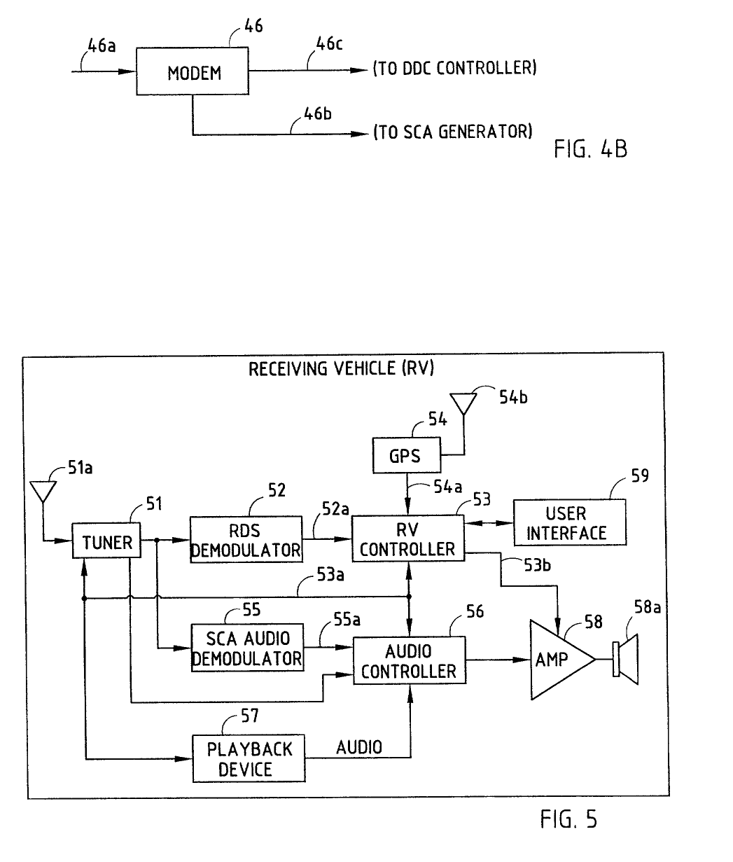

FIG. 4A illustrates a block diagram of a data delivery center and dispatch/tracking center (TC) located together at a radio station facility to form a combined data delivery center 21. The components of combined delivery center 21 include wireless receiver 41, data delivery center (DDC) controller 42, RDS encoder 43, audio subcarrier audio generator (SCA) 44, and wide area transmitter 45.

The radio frequency signal from EV/hazard 11 is received by DDC receiver antenna 41A and communicated to DDC receiver 41. The signal includes the hazard location and may include additional information such as hazard ID information, speed, direction, destination, status, text data, and audio data. Analog audio signal 41B is extracted by receiver 41 and communicated to SCA generator 44 which generates an SCA signal 44A for injection into the FM signal by wide area transmitter 45. SCA generators are well known to those skilled in the art.

Receiver 41 extracts the hazard/EV data 41A and communicates the data to DDC controller 42. DDC controller 42 processes and formats the hazard/EV data 41A. For example, some hazard/EV data may not need to be forwarded to RVs 14. However, it is envisioned that DDC controller 42 will enhance the hazard/EV data by adding additional information useful to RV 14. In one aspect of the invention, a navigation database 42B is used to identify road segment data corresponding to the hazard location. The road segments are broadcast to RV 14 thereby allowing RV 14 to highlight the road segments oil a map display. DDC controller 42 can be implemented as an embedded microcontroller, a personal computer, a workstation, or the like. DDC controller 42 includes memory for storing variables, data, and programs and may include mass storage 42B for storing large amounts of navigation data.

The processed EV location data 42A is communicated to RDS encoder 43 where the data is translated into an RDS signal 43A for injection into the FM signal by wide area transmitter 45. RDS encoder technology is well known to those skilled in the art. However, other techniques of encoding data into a radio frequency are known and may also be used to practice the invention.

Wide area transmitter 45 combines the encoded EV location data 42A and audio 44A with the conventional FM signal and broadcasts the combined signal via antenna 45A. In the alternative, wide area transmitter 45 may be a dedicated transmitter only used to transmit alert signals and no other commercial programming.

In the case of an off-site dispatch/tracking center 12, the block diagram of FIG. 4A may be modified as shown in FIG. 4B. In this embodiment, DDC receiver 41 is replaced by MODEM 46. MODEM 46 receives EV location data from tracking center 12 via tracking signal 46A, preferably over a low-latency dedicated network. MODEM 46 demodulates tracking signal 46A and separates the analog audio 46B and EV data 46C. The signals are communicated to the audio SCA generator 44 and DDC controller 42 respectively and processed similar to the discussion of FIG. 4A.

Turning to FIG. 5, a block diagram of the components in RV 14 is illustrated. The components in RV 14 alert the driver of RV 14 as a function of the location of RV 14 and the location of hazard/EV 11. A predetermined algorithm is used to evaluate whether or not an alert is necessary. The algorithm may be as simple as merely evaluating the distance between hazard/EV 11 and RV 14. Preferably, the algorithm analyzes the data to prevent false alerts for instances in which hazard/EV 11 is within a predetermined distance, yet is not relevant to the driver. More preferably, the algorithm includes additional programming and a navigation database and uses all available data to evaluate if an alert is appropriate and, if needed, to suggest actions to be taken by the driver. For example, the algorithm preferably determines whether an EV is on the same road or on an intercept course and suggests alternative routes if necessary. The algorithm also preferably includes various modes of alert, which are either automatically selected or manually selected by a user. For example, sensitivity may be changed depending on if the RV is, for example, in a metropolitan area, rural area, or on an expressway. Understanding the function of the RV unit, the block diagram of the preferred embodiment is more easily understood.

The major components of RV 14 include tuner 51, RDS demodulator 52, RV microcontroller 53, GPS unit 54, SCA audio demodulator 55, radio audio control 56, playback device 57, and audio amp 58. Tuner 51 receives the FM radio broadcast from delivery center 21 via antenna 51A and recovers a composite data/audio signal 51B. Data/audio signal 51B is input to both RDS demodulator 52 and SCA audio demodulator 55. RDS demodulator 52 extracts the RDS data 52A which includes the non-audio data such as EV location, speed, direction, destination, route, and text messages. SCA audio demodulator 55 extracts the EV audio message 55A.

The location of RV 14 is determined by GPS unit 54, which uses tracking signals from the constellation of GPS satellites via antenna 54B. GPS unit 54 generates an RV location signal 54A indicative of the RV's location. It should be understood that GPS unit 54 is only the preferred positioning technology and several alternatives are discussed elsewhere in this specification.

RV controller 53 inputs RDS data 52A and RV location signal 53A and also controls other components via internal radio bus 53A. RV controller 53 includes memory for variables, data, and program data. The algorithms for evaluating when an alert is necessary or relevant are implemented in the programming of RV controller 53. Text data is output to RV user interface 59 where it preferably is printed on a display screen head-up display or the like. In one embodiment, text data is translated to speech and output to either user interface 59 or radio audio control 56 where speakers are available. Text-to-speech requires a significant amount of processor resources and therefore either a sufficiently powerful processor must be used for RV controller 53 or an additional processor can be added to handle text-to-speech processing. An analog to digital (A/D) converter is also typically used in the text-to-speech synthesis.

In alternate embodiments, outputs are communicated across vehicle buses (not shown) to other devices such as a voice module, navigation system, or telematics system for outputting information to a user.

Other tasks performed by RV controller 53 include controlling tuner 51, playback device 57, radio audio control 56, and audio amp 58 as needed. RV controller 53 causes radio audio control 56 to mute the radio outputs when an alert is received. Audio control 56 may also output audible alarms or messages under the control of RV controller 53 to speaker 58A. In an alternative embodiment, radio volume may be muted via amp enable signal 53B.

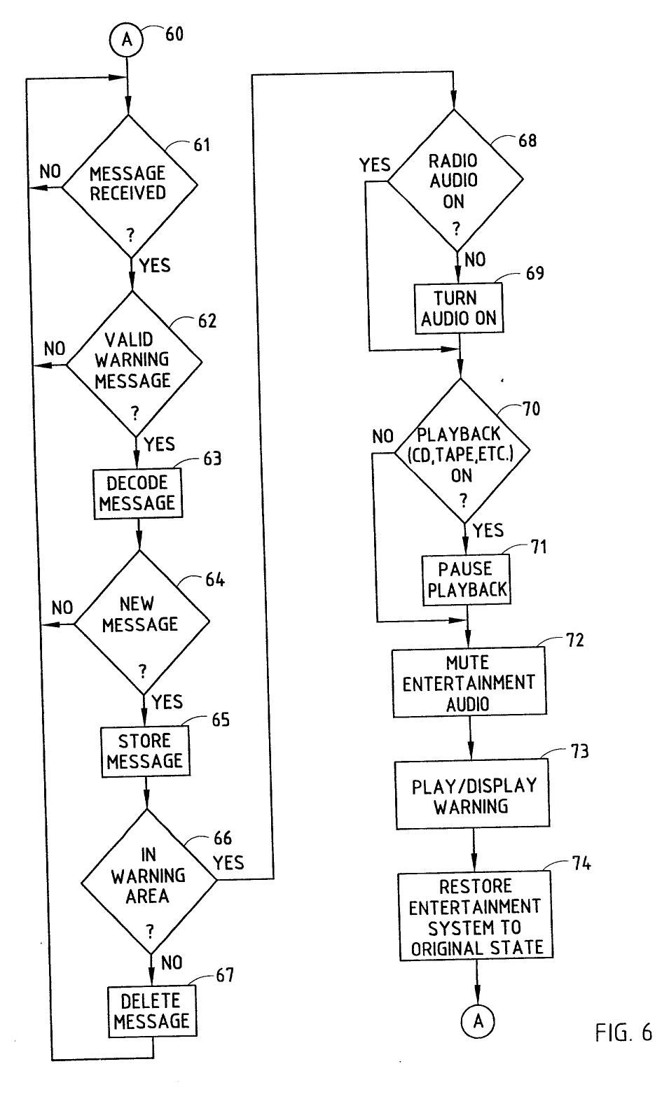

FIG. 6 is a flowchart of the algorithm for the RV controller 53. Beginning from node A in step 60 the algorithm checks for messages received in step 61. These messages are the signals transmitted from either the data delivery center or from the hazard itself. If no messages or data have been received, the algorithm continues to check for messages. If a message is received, the message or data is checked for validity in step 62. If the message is not valid, the algorithm goes back to check for messages in step 61. If the message is valid, the algorithm decodes the message or data in step 63. Next, the algorithm checks if the message is a new message in step 64. If it is not new, the algorithm goes back to the start to check for a message in step 61. If the message is new, the algorithm stores the message in step 65 and continues on to check if the hazard is in the warning area in step 66 (i.e., is the hazard in a location requiring that action be taken or the driver alerted). If not, then the algorithm deletes the message and goes back to check for new messages in step 61. By deleting the messages in this step, the algorithm forces all received messages to appear new.

If the hazard is in the warning area, then the algorithm checks if the radio audio is turned “on” in step 68. If not, then the radio audio is turned on in step 69 so that so that an alert can be communicated via the audio system. The algorithm continues by checking if the playback unit is turned “on” in step 70. If “yes,” the playback unit is paused in step 71 and the entertainment audio is muted in step 72. Next the appropriate alarms, audio, and display warnings are activated in step 73. After the alerts are performed, the algorithm restores the entertainment/radio system to the original state in step 74 and starts the process over at node A in step 60.

A method of the invention follows from the apparatus description above. Beginning with the hazard/EV, the location of the hazard is determined using one or more of the many positioning systems discussed above or, if the hazard is stationary, using preprogrammed coordinates. The hazard location is transmitted either on demand or responsive to activation of a warning indicator (e.g., flashing lights or siren). The transmission is received by a tracking center, a data delivery center, or an RV depending on the specific implementation of the system. The tracking center 12 and/or the data delivery center 13 may reformat and supplement the location data with additional information prior to transmitting the data to the RV 14. The transmission sent to RV 14 uses any of the several techniques and technologies discussed above.

Eventually, the RV receives a transmission containing the hazard location data. The RV determines its location using one of the many positioning systems and also determines if the hazard may be relevant to the driver. Simple implementations make this determination simply as a function of the distance between the hazard and the RV. More sophisticated implementations make this determination as a function of many variables including, but not limited to, distance from the hazard, speed of the hazard and the RV, direction of travel of both vehicles, and destination/route of both vehicles.

Once it is determined that the hazard is relevant, the driver of the RV is alerted. Alerts may include any of the alerts discussed above.

An advantage of the system is that much of the hardware for implementing the system in a RV is already resident in many vehicles. For example, many vehicles are equipped with a receiver as part of an entertainment system. Similarly, many vehicles are equipped with some type of positioning system and a processor as part of either a navigation system or telematics system. Finally, audio and visual outputs are included in entertainment systems, navigation systems, and telematics systems. The invention is capable of being integrated with the other vehicle electronics and thereby reduces implementation costs.

The alert method and system of the present invention achieves significant improvements in alerting vehicles to emergencies and hazards. The invention communicates appropriate data to a RV so that safe and efficient actions may be evaluated and executed. The invention may be integrated into current vehicle systems and requires only minimal hardware changes. Finally, the invention may improve the efficiency of emergency vehicles.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

What is claimed is:

1. A vehicle alert system comprising:
an emergency vehicle (EV) positioning system generating EV location data;
an EV wireless transmitter, in communication with said EV positioning system, for transmitting the EV location data; and
a data delivery center in communication with said EV wireless transmitter, said delivery center having a wide area transmitter for broadcasting said EV location data.

2. The vehicle alert system according to claim 1, further comprising:
a receiving vehicle (RV) positioning system generating RV location data;
an RV receiver, in communication with said wide area transmitter and receiving said EV location data;
an alarm; and
an RV controller, in communication with said RV positioning system and said RV receiver, activating said alarm as a function of said EV location data.

3. The vehicle alert system according to claim 1, further comprising a tracking center, said tracking center receiving said EV location data from said EV wireless transmitter and communicating said EV location data to said data delivery center.

4. The vehicle alert system according to claim 1, wherein technology for said EV positioning system is selected from the group consisting of GPS, GLONASS, dead reckoning, E911, and fixed location data.

5. The vehicle alert system according to claim 2, wherein the technology for said RV positioning system is selected from the group consisting of GPS, GLONASS, LORAN, dead reckoning, and E911.

6. The vehicle alert system according to claim 1, wherein the technology used by said wide area transmitter is selected from the group consisting of FM subcarrier, RDS, CDPD, packet network, and wireless ISP.

7. The vehicle alert system according to claim 2, wherein the alarm is selected from the group consisting of audio alarm, light emitting devices, and a display screen.

8. The vehicle alert system according to claim 2, wherein the RV controller determines a suggested action to be performed as a function of said EV location data and the RV controller communicates said suggested action to the driver.

9. The vehicle alert system according to claim 8, wherein the RV controller determines an alternate route responsive to said EV location data and communicates said alternate route action to the driver.

10. The vehicle alert system according to claim 1, wherein the EV transmitter is installed in an emergency vehicle selected from the group consisting of a police vehicle, a fire truck, an ambulance, a train, a school bus, and a road maintenance vehicle.

11. The vehicle alert system according to claim 2, wherein the alarm outputs speech to the driver.

12. The vehicle alert system according to claim 1, wherein said EV wireless transmitter is activated responsive to activation of said warning indicator.

13. A vehicle warning system comprising:
a hazard positioning system generating hazard location data;
a hazard transmitter in communication with said hazard positioning system and transmitting said hazard location data;
a receiving vehicle (RV) receiver suitable for receiving said hazard location data from said hazard transmitter;
an RV positioning system generating RV location data;
an alarm; and
an RV controller in communication with said RV receiver, said RV positioning system, and said alarm, said RV controller activating said alarm as a function of said hazard location data.

14. The vehicle warning system according to claim 13, wherein said hazard positioning system is installed in an apparatus selected from a group consisting of a police vehicle, a fire truck, an ambulance, a school bus, a train, a road maintenance vehicle, a rail road crossing signal, a road construction warning device, and a school zone warning device.

15. The vehicle warning system according to claim 13, wherein said alarm is selected from the group consisting of a buzzer, a horn, a lamp, a speech message, symbology on a display screen, a sound generated by a speaker, and symbology on a head-up display.

16. The vehicle warning system according to claim 13, further comprising a data delivery center in communication with said hazard transmitter, said delivery center broadcasting said hazard location data to said RV receiver.

17. The vehicle warning system according to claim 13, wherein said alarm is selected from the group consisting of audio alarms, warning lights, display screens, lead-up displays, and entertainment systems.

18. The vehicle warning system according to claim 13, wherein the RV controller determines a suggested action to be performed as a function of said hazard location data and the RV controller communicates said suggested action to the driver.

19. The vehicle warning system according to claim 13, wherein the hazard positioning system is installed in an apparatus selected from the group consisting of a police vehicle, a fire truck, an ambulance, a train, a school bus, a road maintenance vehicle, a rail road crossing signal, a school zone warning device, road construction vehicles, and road construction warning devices.

20. The vehicle warning system according to claim 13, wherein the alarm outputs speech to the driver.

21. A method of communicating warning information from a hazard apparatus to a receiving vehicle (RV), said method comprising the steps of:
determining the location of the hazard apparatus;
transmitting the location of the hazard apparatus;
receiving the hazard apparatus location by a receiver in the receiving vehicle; and
alerting a driver of the receiving vehicle of the hazard apparatus.

22. The method of communicating warning information to a receiving vehicle according to claim 21, wherein prior to the alerting step), the method further comprises the steps of:
determining the location of the receiving vehicle; and
determining if the hazard apparatus is relevant to a driver of the receiving vehicle based on predefined criteria.

23. The method of communicating warning information to a receiving vehicle according to claim 22, wherein the step of alerting includes an alert selected from the group consisting of: generating an aural alert, generating a verbal alert, generating visual alert, and displaying a warning on a display screen.

24. The method of communicating warning information to a receiving vehicle according to claim 22, further comprising the steps of:
determining a suggested action as a function of said hazard apparatus location; and
communicating said suggested action to the driver of the receiving vehicle.

25. The method of communicating warning information to a receiving vehicle according to claim 21, wherein the step of transmitting includes transmitting the hazard apparatus location to a data delivery center and the step of receiving includes receiving the hazard apparatus location from the data delivery center.

26. The method of communicating warning information to a receiving vehicle according to claim 21, wherein the step of determining the location of a hazard apparatus uses a method of determining location selected from the group consisting of satellite positioning systems, the global positioning system (GPS), GLONASS, LORAN, gyroscope technology, dead reckoning, E-911, and a fixed pre-programmed location.

27. A warning system in an automobile, said system comprising:
a receiving vehicle (RV) receiver suitable for receiving hazard location data broadcast via electromagnetic radiation;
an RV positioning system generating RV location data;
an alarm; and,
an RV controller in communication with said RV receiver, said RV positioning system, and said alarm, said RV controller activating said alarm as a function of said hazard location data.

28. A warning system in an automobile according to claim 27, wherein the RV controller determines a suggested action to be performed as a function of said EV location data and the RV controller communicates said suggested action to the driver.

29. A warning system in an automobile according to claim 28, wherein the RV controller determines an alternate route responsive to said EV location data and communicates said alternate route action to the driver.
